(19) United States
(12) Patent Application Publication
(10) Pub. No.: US 2026/0003676 A1
(43) Pub. Date: Jan. 1, 2026

(54) NON-TRANSITORY COMPUTER-READABLE RECORDING MEDIUM, JOB EXECUTION CONTROL METHOD, AND JOB EXECUTION CONTROL DEVICE

(71) Applicant: Fujitsu Limited, Kawasaki-shi (JP)

(72) Inventor: Jun KATO, Kawasaki (JP)

(73) Assignee: Fujitsu Limited, Kawasaki-shi (JP)

(21) Appl. No.: 19/218,695

(22) Filed: May 27, 2025

(30) Foreign Application Priority Data
Jun. 28, 2024 (JP) 2024-105196

(51) Int. Cl. G06F 9/48

(52) U.S. Cl. CPC G06F 9/4887

(57) ABSTRACT

A non-transitory computer-readable recording medium stores therein a job execution control program that causes a computer to execute a process including receiving a first job for performing batch processing and a second job for performing interactive processing with a user, determining tightness of a time resource used to cause a predetermined calculation node to alternately execute the first job and the second job according to a lapse of time;
in a case where the time resource is not tight, allocating an equal time to the first job and the second job and first causing the predetermined calculation node to make first execution, and in a case where the time resource is tight, increasing priority of execution of the second job, allocating a time to the first job and the second job, and second causing the predetermined calculation node to make second execution.

### CROSS-REFERENCE TO RELATED APPLICATION

This application is based upon and claims the benefit of priority of the prior Japanese Patent Application No. 2024-105196, filed on Jun. 28, 2024, the entire contents of which are incorporated herein by reference.

### FIELD

The embodiments discussed herein are related to a computer-readable recording medium, a job execution control method, and a job execution control device.

### BACKGROUND

In recent years, with the progress of information processing technology such as artificial intelligence (AI), a high performance computing (HPC) system having high calculation capability and data processing speed such as a supercomputer has attracted attention. The HPC system can use a large number of processors to process large amounts of data to solve complex problems at high speed.

Although improvement in processing performance has been mainly required for such an HPC system so far, interactivity is also required from now on in order to further improve convenience and efficiency. For example, in program development, interactive processing such as generating a code and executing the generated code is repeated. In addition, in the digital twin technology in which the real world is duplicated in the digital space and simulation is performed, interactive processing of inputting data to the duplicated virtual space world, acquiring result information, and further inputting data based on the acquired result information is repeated.

Here, since high performance and reproducibility are emphasized in the conventional HPC system, a batch method of space division in which as many jobs as possible are executed in parallel at the same time is mainly used as a technique for improving the efficiency of batch processing. As a technique of the batch method of space division, there are the following techniques. For example, the HPC system has a batch backfilling function of executing jobs in changed order when there are available resources, but executing jobs in order of input when there are no available resources for any job.

In addition, in the HPC system, distributed parallel processing is performed using a plurality of processes on an operating system (OS) as a method of time division of a job. The distributed parallel processing is based on gang scheduling in which switching is performed in units of jobs for each certain time slice. The gang scheduling includes, for example, a job scheduler included in a management node dynamically determining which job is to be processed by each calculation node, and collectively synchronizing and switching jobs across a plurality of calculation nodes. Since each job corresponds to an individual HPC application, it can be said that the job scheduler collectively synchronizes and switches the HPC application.

In addition, as a technique of time division, a technique has been proposed in which a time allocation rate within a cycle is determined for a parallel program, a processor is allocated one by one to each parallel process generated by the parallel program, and processing is executed, and when a time corresponding to the time allocation rate is reached, the processing is terminated.
Patent Literature 1: International Publication Pamphlet No. WO 2002/069174

### SUMMARY

According to still another aspect of an embodiment, a non-transitory computer-readable recording medium stores therein a job execution control program that causes a computer to execute a process. The process includes receiving a first job for performing batch processing and a second job for performing interactive processing with a user, determining tightness of a time resource used to cause a predetermined calculation node to alternately execute the first job and the second job according to a lapse of time, in a case where the time resource is not tight, allocating an equal time to the first job and the second job and first causing the predetermined calculation node to make first execution, and in a case where the time resource is tight, increasing priority of execution of the second job, allocating a time to the first job and the second job, and second causing the predetermined calculation node to make second execution.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an HPC system according to the embodiment;

FIG. 2 is a diagram illustrating an example of an execution state of a batch job;

FIG. 3 is a diagram illustrating designation of a maximum delay time using an overhead rate;

FIG. 4 is a diagram illustrating an example of job scheduling;

FIG. 5 is a diagram illustrating an example of an execution state of a job by gang scheduling;

FIG. 6 is a diagram illustrating an example of an execution state of a job by the HPC system according to the embodiment;

FIG. 7 is a flowchart of a job scheduling process by a job scheduler;

FIG. 8 is a flowchart of a job management process by a scheduler agent; and

FIG. 9 is a hardware configuration diagram of a computer.

### DESCRIPTION OF EMBODIMENTS

However, a process having interactivity is required to respond to an input with a short time lag from the viewpoint of user's request and operability. In this regard, in the conventional batch processing method of space division, since a job is not started immediately when there is no free resource, it is difficult to realize appropriate interactivity, and it is difficult to improve convenience. In addition, in the case of the HPC system, the ratio between jobs that are required to have interactivity and jobs that are not required to have interactivity is often different depending on the time zone. Therefore, simply prioritizing gang scheduling increases the processing time of a job that does not require interactivity and has a designated end time, making it difficult to complete the processing within the time. Therefore, processing performance for a specific job may be deteriorated.

In addition, in the technology of determining the time allocation rate within the cycle and executing the parallel process, the allocation of the time allocation rate is static, and it is difficult to appropriately execute all the jobs for a job requiring interactivity. Therefore, processing performance for a specific job may be deteriorated.

Preferred embodiments will be explained with reference to accompanying drawings. Note that the computer-readable recording medium, the job execution control method, and the job execution control device disclosed in the present application are not limited by the following embodiments.

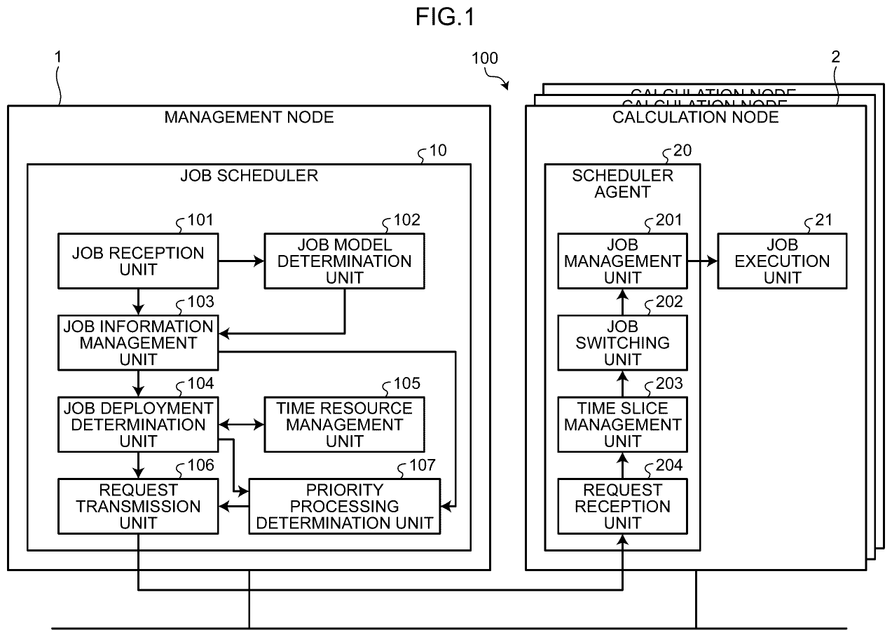

FIG. 1 is a block diagram of an HPC system according to the embodiment. As illustrated in FIG. 1, an HPC system 100 according to the present embodiment includes a management node 1 and a plurality of calculation nodes 2. Here, the node is an information processing unit capable of executing information processing such as calculation, and is, for example, a server or the like. The management node 1 and the calculation node 2 are connected by a network.

The management node 1 schedules execution of a job input from the user to the HPC system 100, deploys each job to the calculation node 2, and makes a notification of a schedule for each job. Each of the calculation nodes 2 executes the deployed job according to the notified schedule. Details of the management node 1 and the calculation node 2 will be described below. The management node 1 corresponds to an example of a “job execution control device”.

As illustrated in FIG. 1, the management node 1 includes a job reception unit 101, a job model determination unit 102, a job information management unit 103, a job deployment determination unit 104, a time resource management unit 105, a request transmission unit 106, and a priority processing determination unit 107.

The job reception unit 101 acquires job information input from the user. For example, the user can input a job to be executed to the HPC system 100 using an information processing terminal device (not illustrated) connected to a network. In this case, the user also inputs job information such as the maximum delay time and the maximum execution time according to the input job. The job reception unit 101 outputs the acquired job information to the job model determination unit 102.

The job model determination unit 102 receives an input of input job information from the job reception unit 101. Next, the job model determination unit 102 determines a job model corresponding to the type of the input job. For example, when the job information includes a value corresponding to the job model designated by the user, the job model determination unit 102 determines the job model from the designated value. The job model determination unit 102 outputs the information about the job and the information about the determined job model to the job information management unit 103.

Here, a job model will be described. In the present embodiment, job models include Strict Batch, Weak Batch, On-Demand, and Spot.

Strict Batch is a job model that waits until any calculation node 2 can be occupied, and is deployed to the calculation node 2 and executed when the calculation node 2 can be occupied. Hereinafter, a job whose job model is Strict Batch is referred to as a Strict Batch job. The Strict Batch job occupies the deployed node until the execution of the job is completed.

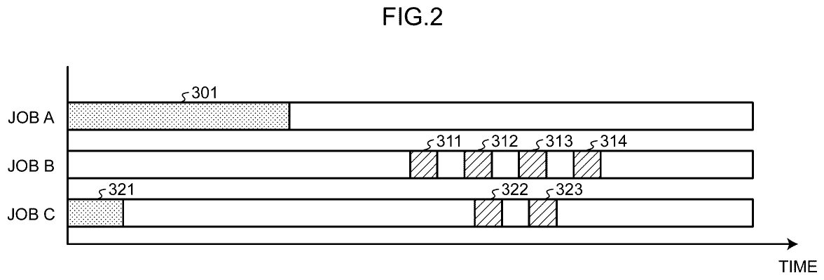

FIG. 2 is a diagram illustrating an example of an execution state of a batch job. In FIG. 2, the vertical axis represents individual jobs, and the horizontal axis represents a lapse of time. The batch job is a job that executes batch processing of performing a predetermined series of processing without performing communication with the user. A job whose job model is Strict Batch or Weak Batch corresponds to a batch job. In FIG. 2, a white region is a time when a batch job is executed. In addition, regions 301 and 321 to which dot patterns are added are times when the batch job is in a state of waiting for execution in the queue. In addition, regions 311 to 314, 322, and 323 to which hatched patterns are added are times when another job other than the batch job is executed.

For example, the Strict Batch job is executed as in the job A in FIG. 2. Here, a case where the overhead rate is set to 0 corresponds to a case where the maximum delay time is designated for the Strict Batch job. The maximum delay time is not required to be designated for the Strict Batch job, but when the maximum delay time is designated, the maximum delay time can be designated by setting the overhead rate to 0. The maximum delay time is the upper limit value of the execution waiting time in the queue of the Strict Batch job. In this case, the execution waiting time in the queue indicated by the region 301 may be less than the designated maximum delay time.

Weak Batch is a job model that performs worst value guarantee while permitting node sharing. The node sharing is a function of time division of a job that causes a specific calculation node 2 to interrupt execution of another job while executing the specific job and alternately executes the specific job and the another job. Then, in the node sharing, the time allocated to execute each job in the specific calculation node 2 corresponds to a “time resource”. The worst value is a state in which the execution of the job is completed at the latest time at which the user can comply with the designated maximum delay time. Hereinafter, a job whose job model is Weak Batch is referred to as a Weak Batch job.

The maximum delay time is also designated by the user for the Weak Batch job. The Weak Batch job is executed in consideration of node sharing so as not to exceed the maximum delay time. In the case of the Weak Batch job, the maximum delay time corresponds to the upper limit value of the time obtained by adding the execution waiting time in the queue and the delay time in job supply.

When the execution waiting time in the queue is close to the maximum delay time, it is difficult to secure the time allocated for node sharing, and thus the Weak Batch job is executed as in the Strict Batch job. That is, the Weak Batch job in this case is executed as in job A in FIG. 2. In this case, the execution waiting time in the queue indicated by the region 301 may be less than the designated maximum delay time.

On the other hand, when the execution waiting time in the queue is smaller than the maximum delay time, the Weak Batch job is executed while node sharing with other jobs is performed within a range of time obtained by subtracting the execution waiting time in the queue from the maximum delay time. The Weak Batch job in this case is executed as in job B or C in FIG. 2.

In the case of the job B, there is no execution waiting time in the queue, and the sum of the time of execution of the other jobs indicated by the regions 311 to 314 may be less than the maximum delay time. In the case of the job C, the sum of the execution waiting time in the queue indicated by the region 321 and the time of execution of the other jobs indicated by the regions 322 and 323 may be less than the maximum delay time.

Furthermore, in designation of the maximum delay time for the Weak Batch job, the time itself may be designated, but designation using another index may be performed. For example, since it can be assumed that the longer the execution time is, the more acceptable the longer delay time is, the overhead rate of the execution time may be used to designate the maximum delay time.

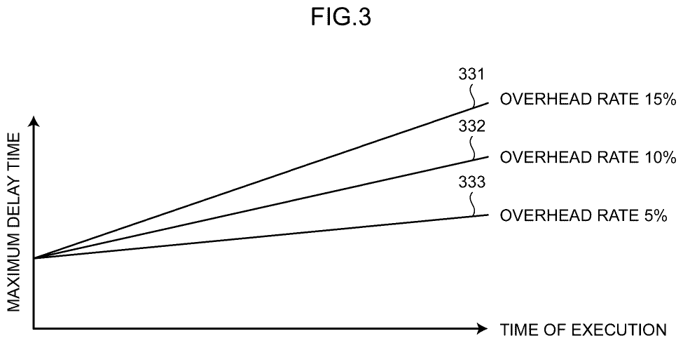

FIG. 3 is a diagram illustrating designation of a maximum delay time using an overhead rate. In FIG. 3, the vertical axis represents the maximum delay time, and the horizontal axis represents the execution time. A graph 331 illustrates a change in the maximum delay time according to the execution time when the overhead rate is 15%. A graph 332 illustrates a change in the maximum delay time according to the execution time when the overhead rate is 10%. A graph 333 illustrates a change in the maximum delay time according to the execution time when the overhead rate is 5%.

Regardless of the overhead rate, the maximum delay time increases from a fixed initial value according to the execution time. However, the smaller the overhead rate, the smaller the increase rate according to a lapse of time of the maximum delay time. In a case where the overhead rate is 0%, the maximum delay time is a constant value, and for the Strict Batch job, it is preferable to use the maximum delay time with the overhead rate set to 0.

Here, when providing a service using the HPC system 100, the use price is generally set to be higher as the maximum delay time is longer. Therefore, the lower the overhead rate is set to be, the more the price can be significantly suppressed. When causing the HPC system 100 to execute the Weak Batch job, the user can select the overhead rate according to the price.

Here, since the specific maximum delay time does not have to be known in the Weak Batch job, even when the user does not directly grasp the maximum delay time, the user can designate the maximum delay time at an indirect ratio such as an overhead rate, so that usability can be improved. In addition, in a case where a designation method based on an indirect ratio such as an overhead rate is used, the maximum delay time may dynamically increase as the execution time elapses. In such a case, even when the maximum delay time is used up once and the Weak Batch job is occupied and executed, the margin for the maximum delay time is recovered with time, so that the HPC system 100 is capable of executing the Weak Batch job again by node sharing.

In addition, a maximum execution time has been designated for scheduling a conventional batch job. On the other hand, in the HPC system 100 according to the present embodiment, the maximum execution time of Strict Batch jobs and Weak Batch jobs, that is, batch jobs in general, is not required to be designated. This is because of the following reason. The maximum execution time is mainly used for the backfilling function, but in the HPC system 100 according to the present embodiment, since a job is allocated by time division, the importance of the backfilling function decreases. In addition, since a batch job is executed for a long time and has a large absolute value of an error, estimation of the maximum execution time is difficult and is not very reliable. However, the maximum execution time may be set in order to end the batch job after a certain period of time in order to avoid long-time execution. For example, the maximum execution time of the Weak Batch job may be set such that the job can be executed for up to 24 hours when not designated, and the maximum execution time is designated if the job is executed for longer. This Weak Batch job corresponds to an example of a “first job”.

On-Demand is a job model that permits node sharing and is executed by designating a maximum execution time. The maximum execution time is an allowable time until completion of execution of the job. Hereinafter, a job whose job model is On-Demand is referred to as an On-Demand job. It is sufficient that the execution of the On-Demand job is completed within less than the maximum execution time from the input.

Here, the maximum execution time of the On-Demand job is designated by the user, but there is a gap between the designated maximum execution time and the actual time of execution in many cases. This is because it is difficult to predict the execution time from the viewpoint of the user, and it is assumed that the maximum execution time is set longer with a margin. For example, it is conceivable that the user sets the maximum execution time to about one hour considering that there is a possibility that execution of an On-Demand job that is predicted to actually end in about 30 minutes is delayed due to an input output (IO) process or the like.

In order to secure the worst value of the Weak Batch job, the user who executes the On-Demand job time reserves the maximum execution time when the job is input, but in a case where the maximum execution time is excessively reserved, a large deviation occurs between the actual time of execution and the maximum execution time. The maximum delay time of the Weak Batch job is also a time resource for executing the On-Demand job or the Spot job, and when the overall time margin is tight, it is preferable to reduce the excessive reservation and execute as many On-Demand jobs and Spot jobs as possible. This On-Demand job corresponds to an example of a “second job”.

Spot is a job model that permits node sharing and is pre-empted at any timing. That is, Spot is a job model that effectively uses available resources. Hereinafter, a job whose job model is Spot is referred to as a Spot job.

Both the On-Demand job and the Spot job are jobs that perform interactive processing in which the process proceeds with processing through two-way communication with the user. Hereinafter, the On-Demand job and the Spot job are collectively referred to as interactive jobs.

Here, the designation of the maximum execution time designated for the On-Demand job and the pre-emption performed for the Spot job are elements for guaranteeing the worst value of the Weak Batch job. For example, in a case where the On Demand job is deployed to a specific calculation node 2, it is determined whether the On Demand job can be executed in node sharing with the Weak Batch job on the assumption that the On Demand job consumes the maximum execution time. In the case of node sharing, it is possible to determine whether execution can be performed in node sharing with the Weak Batch job depending on whether the maximum delay time of the Weak Batch job is not exceeded. In this case, the maximum execution time is a time obtained by counting a time consumed by the On-Demand job instead of the entire time of execution (Wall Time) including node sharing. In addition, the Spot job is pre-empted and stopped when the execution of the Weak Batch job is about to exceed the maximum delay time.

It can be said that a batch job is a job intended for execution in a long time, and an interactive job is a job intended for execution in a short time.

The job information management unit 103 receives an input of job information and job model information from the job model determination unit 102. In addition, the job information management unit 103 receives an input of information about the job model of the input job from the job model determination unit 102. Then, the job information management unit 103 manages the job information and the job model for the job.

More specifically, the job information management unit 103 holds information indicating whether the job is the Strict Batch job, the Weak Batch job, the On-Demand job, or the Spot job. In addition, the job information management unit 103 holds information about the maximum delay time of the Weak Batch job and the maximum execution time of the On-Demand job. In addition, the job information management unit 103 holds information about a job input time which is a time when a job is input by a user. The job information management unit 103 also holds information about the job itself.

The job deployment determination unit 104 includes a queue (not illustrated) for storing batch jobs. The job deployment determination unit 104 acquires information about the input job from the job information management unit 103. Hereinafter, the job acquired by the job deployment determination unit 104 is referred to as a “target job”. Then, the job deployment determination unit 104 determines at which timing and in which node the target job can be deployed according to the job model of the target job. For example, the job deployment determination unit 104 determines job deployment in the following procedure.

The job deployment determination unit 104 determines whether a resource for job execution exists for the target job based on the job model. Here, a case where execution order control is performed using fast in fast out (FIFO) scheduling for a job will be described as an example.

A case where the target job is a Strict Batch job will be described. The job deployment determination unit 104 calculates the sum of the number of free nodes, which is the number of calculation nodes 2 that are not used at that time, and the number of calculation nodes 2 that execute the Spot job and have not executed jobs of another job model.

Here, since the Spot job can be stopped at a desired timing by pre-emption, it can be said that the calculation node 2 that executes the Spot job and has not executed a job of another job model is substantially a free node. Therefore, the total value calculated by the job deployment determination unit 104 can be said to be the number of calculation nodes 2 that are not substantially used, and is hereinafter referred to as “the number of substantially free nodes” and may be referred to as “Node_{free}”. In addition, the number of calculation nodes 2 used in the target job is referred to as the “the number of used nodes” and may be referred to as “Node_{required}”.

Then, the job deployment determination unit 104 determines whether the number of substantially free nodes is equal to or larger than the number of used nodes, that is, Node_{free}≥Node_{required}. In addition, since the scheduling is FIFO scheduling, the job deployment determination unit 104 determines whether there is another Strict Batch job or Weak Batch job stored in the queue and waiting for execution. When the above two conditions are satisfied, the job deployment determination unit 104 determines that a resource for job execution exists for the target job that is the Spot job.

Next, a case where the target job is a Weak Batch job will be described. First, the job deployment determination unit 104 calculates the number of substantially free nodes.

Secondly, the job deployment determination unit 104 calculates the number of calculation nodes 2 that can be used when the On-Demand job is already in operation and the Weak Batch job is to be deployed from now.

Specifically, the job deployment determination unit 104 calculates the number of calculation nodes 2 in which the sum of the maximum execution time of the on-demand job being executed is greater than 0 and less than the maximum delay time of the Weak Batch job that is the target job, and the Weak Batch job is not executed.

Here, the sum of the maximum execution time of the On-Demand job being executed in the specific calculation node 2 is represented by a symbol “SumMaxExeTime”, and the maximum delay time of the Weak Batch job, which is the target job, is represented by a symbol of “MaxLatTime”. That is, the job deployment determination unit 104 calculates the number of calculation nodes 2 in which 0<SumMaxExeTime<MaxLatTime and the Weak Batch job is not executed. 0<SumMaxExeTime indicates that one or more On-Demand jobs are executed in the calculation node 2. SumMaxExeTime<MaxLatTime indicates that the designated maximum delay time is not exceeded even when the target job is deployed to the calculation node 2. Hereinafter, the number of calculation nodes 2 calculated by the job deployment determination unit 104 is referred to as “the number of nodes transitionable from OD to WB”, and may be referred to as “Node_{od-wb}”. Here, OD represents “On-Demand”, and WB represents “Weak Batch”.

Then, the job deployment determination unit 104 calculates the sum of the number of substantially free nodes and the number of nodes transitionable from OD to WB, that is, Node_{free}+Node_{od-wb}. Then, the job deployment determination unit 104 determines whether the calculated total value is equal to or larger than the number of used nodes, in other words, Node_{free}+Node_{od-wb}≥Node_{required}. In addition, the job deployment determination unit 104 determines whether there is another Strict Batch job or Weak Batch job stored in the queue and waiting for execution. When the above two conditions are satisfied, the job deployment determination unit 104 determines that a resource for job execution exists for the target job that is a Weak Batch job.

Next, a case where the target job is an On-Demand job will be described. First, the job deployment determination unit 104 calculates the number of substantially free nodes.

Secondly, the job deployment determination unit 104 calculates the calculation node 2 that can be used when the On-Demand job has already been operated and the On-Demand job or the Spot job is to be deployed. Specifically, the job deployment determination unit 104 calculates the number of calculation nodes 2 in which the number of On-Demand jobs or Spot jobs being executed is greater than 0 and less than the maximum simultaneous execution number of On-Demand jobs or Spot jobs in the node, and the Weak Batch job is not executed.

Here, the number of On-Demand jobs or Spot jobs being executed in a specific calculation node 2 is represented as “SumIntJob”, and the maximum simultaneous execution number of On-Demand jobs or Spot jobs being executed is represented as “MaxIntjob”. That is, the job deployment determination unit 104 calculates the number of calculation nodes 2 in which 0<SumintJob<MaxIntJob and the Weak Batch job is not executed. Hereinafter, the number of calculation nodes 2 calculated by the job deployment determination unit 104 is referred to as “the number of OD-usable nodes” and may be referred to as “Node_{od-int}”.

Third, the job deployment determination unit 104 calculates the number of calculation nodes 2 that can be used when the Weak Batch job is already in operation and the On-Demand job is to be deployed from now.

Specifically, the job deployment determination unit 104 identifies the calculation node 2 in which the number of On-Demand jobs or Spot jobs being executed is less than the maximum simultaneous execution numbers of On-Demand jobs or Spot jobs in the node. Then, the job deployment determination unit 104 calculates, among the identified calculation nodes 2, the number of calculation nodes 2 in which the Weak Batch job is being executed and the time which is not yet reserved for the On-Demand job in the Weak Batch job being executed is equal to or longer than the maximum execution time of the On-Demand job to be deployed.

Here, the time that is not yet reserved for the On-Demand job in the Weak Batch job being executed is represented as “WBTimeLeft”, and the maximum execution time of the On-Demand job to be deployed is represented as “MaxExeTime”. That is, the job deployment determination unit 104 calculates the number of calculation nodes 2 in which SumintJob<MaxIntJob is satisfied, the Weak Batch job is being executed, and WBTimeLeft≥MaxExeTime is satisfied. Hereinafter, the number of calculation nodes 2 calculated by the job deployment determination unit 104 is referred to as “the number of nodes transitionable from WB to OD”, and may be referred to as “Node_{wb-od}”.

Then, the job deployment determination unit 104 determines whether the sum of the number of substantially free nodes, the number of OD-usable nodes, and the number of nodes transitionable from WB to OD is equal to or larger than the number of used nodes, in other words, Node_{free}+Node_{od-int}+Node_{wb-od}≥Node_{required}. When this condition is satisfied, the job deployment determination unit 104 determines that a resource for job execution exists for a target job that is an On-Demand job.

In this manner, the job deployment determination unit 104 determines whether the On-Demand job, which is the second job, can be deployed to the predetermined calculation node 2, that is, whether the second job can be executed by the predetermined calculation node 2. Here, the predetermined calculation node 2 is a set of calculation nodes 2 counted as the number of substantially free nodes, the number of OD-usable nodes, or the number of nodes transitionable from WB to OD.

Next, a case where the target job is a Spot job will be described. First, the job deployment determination unit 104 calculates the number of substantially free nodes. Secondly, the job deployment determination unit 104 calculates the number of OD-usable nodes.

Third, the job deployment determination unit 104 calculates the number of calculation nodes 2 that can be used when the Weak Batch job is already in operation and the Spot job is to be deployed. Specifically, the job deployment determination unit 104 identifies the calculation node 2 in which the number of On-Demand jobs or Spot jobs being executed is less than the maximum simultaneous execution numbers of On-Demand jobs or Spot jobs in the node. Then, the job deployment determination unit 104 calculates, among the identified calculation nodes 2, the number of calculation nodes 2 in which the Weak Batch job is executed and a time that has not yet been reserved for the On-Demand job in the Weak Batch job being executed is greater than 0.

That is, the job deployment determination unit 104 calculates the number of calculation nodes 2 in which SumintJob<MaxIntJob is satisfied, the Weak Batch job is being executed, and WBTimeLeft>0 is satisfied. Hereinafter, the number of calculation nodes 2 calculated by the job deployment determination unit 104 is referred to as “the number of nodes transitionable from WB to SP”, and may be referred to as “Node_{wb-spot}”. Here, SP represents “Spot”.

Then, the job deployment determination unit 104 determines whether the sum of the number of free nodes, the number of OD-usable nodes, and the number of nodes transitionable from WB to SP is equal to or larger than the number of used nodes, in other words, Node_{free}+Node_{od-int}+Node_{wb-spot}≥Node_{required}. When this condition is satisfied, the job deployment determination unit 104 determines that a resource for job execution exists for a target job that is an On-Demand job.

In a case where there is no resource for job execution of the target job, the job deployment determination unit 104 determines whether the target job is a batch job or an interactive job. When the target job is a batch job, the job deployment determination unit 104 stores the target job in the queue. On the other hand, when the target job is an interactive job, the job deployment determination unit 104 notifies the user of an error. For example, when the target job is an On-Demand job that is a second job, the job deployment determination unit 104 makes a notification of an error when there is no resource for job execution of the target job, that is, when the predetermined calculation node 2 is not capable of executing the second job.

Since the interactive job is required to be immediately executed, the job deployment determination unit 104 makes an error notification if the resource is insufficient and the target job that is the interactive job is not immediately executed. However, since the job deployment determination unit 104 reschedules the job so as to immediately execute the interactive job, the occurrence of this error can be suppressed to a low level.

When there is a resource for job execution of the target job, the job deployment determination unit 104 determines deployment of the target job to the calculation node 2 that can be used. Next, the job deployment determination unit 104 instructs the time resource management unit 105 to determine that time resource is insufficient.

Thereafter, the job deployment determination unit 104 acquires a result of the time resource insufficiency determination from the time resource management unit 105. When the time resource is not insufficient, the job deployment determination unit 104 outputs the input job and the information about the calculation node 2 of the deployment destination of the job to the request transmission unit 106, and ends the job deployment processing.

On the other hand, in a case where the time resource is insufficient, the job deployment determination unit 104 causes the priority processing determination unit 107 to execute priority processing determination. Thereafter, the job deployment determination unit 104 outputs the input job and information about the calculation node 2 of the deployment destination of the job to the request transmission unit 106, and ends the job deployment processing.

The time resource management unit 105 receives an execution instruction of the time resource insufficiency determination from the job deployment determination unit 104. Then, the time resource management unit 105 can determine whether the time resource is insufficient using the following determination index. Thereafter, the time resource management unit 105 notifies the job deployment determination unit 104 of the insufficient determination result of the time resource.

Here, the determination as to whether the time resource is insufficient is not a determination as to a state in which execution of the target job is difficult, but a determination as to whether the time resource for executing the input job is insufficient when another job is input, that is, whether the time resource has a margin. That is, the determination as to whether the time resource is insufficient corresponds to an example of the “determination as to whether the time resource is tight”. The job deployment determination unit 104 determines tightness of a time resource to be used for causing the predetermined calculation node 2 to alternately execute a Weak Batch job, which is a first job, and an On-Demand job, which is a second job, according to a lapse of time. In addition, the job deployment determination unit 104 acquires the maximum delay time, which is an upper limit value of the delay of the completion of execution of the first job, and the maximum execution time, which is an upper limit value of the time of execution of the second job, and determines tightness of time resources based on the maximum delay time and the maximum execution time. In addition, the job deployment determination unit 104 determines tightness of time resources in a case of changing the predetermined calculation node 2 from a state of executing the first job to a state of alternately executing the first job and the second job.

The time resource management unit 105 can determine whether the time resource is insufficient based on how much the time resource is available in units of nodes using the number of substantially free nodes (Node_{free}) as an index. For example, the time resource management unit 105 can determine that the time resource is insufficient when the number of substantially free nodes is less than 10% of the total number of all the calculation nodes 2.

In addition, when the Weak Batch job is not moving, the time resource management unit 105 can use, as an index, a WB non-execution free resource indicating how much the time resource is free. Here, the WB non-execution free resource may be represented by a symbol “IntJob_{free}”. For example, the time resource management unit 105 identifies an interactive job execution node which is the calculation node 2 that executes an interactive job and does not execute a batch job. Then, the time resource management unit 105 can set the sum of values obtained by subtracting the number of On-Demand jobs or the number of Spot jobs being executed from the maximum simultaneous execution number of On-Demand jobs or Spot jobs in each interactive job execution node as the WB non-execution free time. That is, the time resource management unit 105 can calculate the WB non-execution free resource as

$${IntJob}_{free} = {\sum }_{interactive job execution node} ( MaxIntJob - SumIntJob ) .$$

For example, the time resource management unit 105 can determine that the time resource is insufficient when the WB non-execution free resource is less than 10% of the sum of the maximum simultaneous execution number of On-Demand jobs or Spot jobs of the interactive job execution node.

Furthermore, the time resource management unit 105 can use, as an index, a WB job execution free resource indicating how much the resource is free in a case where the Weak Batch job is moving. Here, the WB execution free resource may be referred to as “total WBTimeLeft”. For example, the time resource management unit 105 can set, as the WB job execution free resource, the sum of the time not yet reserved for the On-Demand job in the Weak Batch job being executed. That is, the time resource management unit 105 can calculate the WB execution free resource as total WBTimeLeft=ΣWBTimeLeft. For example, the time resource management unit 105 can determine that the time resource is insufficient when the WB job execution free resource is less than 10 hours.

In addition, the time resource management unit 105 may determine whether the time resource is insufficient by using any or all combinations of the node-unit free time, the WB non-execution free time, and the WB execution free time.

When the time resource is insufficient, the priority processing determination unit 107 receives an execution instruction of priority processing determination from the job deployment determination unit 104. Then, the priority processing determination unit 107 prioritizes the On-Demand job among the jobs executed by each calculation node 2. Then, the priority processing determination unit 107 determines a schedule of priority processing for preferentially processing the prioritized job. Thereafter, the priority processing determination unit 107 notifies the request transmission unit 106 of the determined schedule of the priority processing.

For example, the priority processing determination unit 107 holds information about the time slice which is a time resource having a predetermined time length. Then, the priority processing determination unit 107 creates a schedule of priority processing by increasing the number of allocated time slices of a predetermined length to a job that has a fixed time interval of time slices and is prioritized instead of round robin. Specifically, in a case where two jobs are switched in a time slice of 1 second, the priority processing determination unit 107 creates a schedule in which the priority job is executed N times (N seconds) and then another job is executed once (1 second) instead of alternately allocating time slices. This method is number-based priority processing.

In addition, the priority processing determination unit 107 may create a schedule of priority processing by dynamically allocating time intervals of time slices. For example, the priority processing determination unit 107 creates a schedule of priority processing by allocating a long time slice to a job to be prioritized and allocating a short time slice to other jobs. This method is time-based priority processing.

A job is executed by the calculation node 2 based on the schedule finally created by the priority processing determination unit 107, and the execution by the calculation node 2 corresponds to an example of “second execution”. That is, in a case where the time resource is tight, the priority processing determination unit 107 increases the priority of the execution of the On-Demand job, which is the second job, allocates time to the Weak Batch job, which is the first job, and the second job, and causes the predetermined calculation node 2 to make second execution. The priority processing determination unit 107 may increase the number of time slices allocated to the second job as compared with the number of time slices allocated to the first job. In addition, the priority processing determination unit 107 may set the length of the time slice allocated to the second job to be longer than that of the first job.

Here, the priority processing determination unit 107 is not required to allocate time slices at a constant rate, and may determine the schedule of the priority processing so as to increase the degree of priority according to a lapse of time. That is, the priority processing determination unit 107 may change the priority according to the tight state of the time resource. For example, the operation of the priority processing determination unit 107 that increases the degree of priority will be described with an example in which the time resource management unit 105 determines that the time resource is insufficient when the WB job execution free resource is less than 10 hours.

When the priority processing determination unit 107 determines that the WB job execution free resource is less than 10 hours, the time resource management unit 105 receives an execution instruction of the priority processing determination and information about the WB job execution free resource from the job deployment determination unit 104. Then, the priority processing determination unit 107 creates a schedule of priority processing by allocating twice a time slice having a predetermined length to the priority job and allocating one time slice having a predetermined length to the other jobs.

Further, the priority processing determination unit 107 continuously receives information about the WB job execution free resource from the job deployment determination unit 104. When the WB job execution free resource is less than 5 hours, the priority processing determination unit 107 creates a schedule of priority processing by allocating four times a time slice having a predetermined length to the priority job and allocating one time slice having a predetermined length to the another job. As described above, the priority processing determination unit 107 may change the degree of time slice allocation.

In addition, the insufficiency determination threshold value for determining the insufficiency of the index used for the time resource may be made variable, and the priority processing determination unit 107 may change the degree of priority processing of the job prioritized based on the degree of insufficiency according to the change in the threshold value. The degree of the priority processing is, for example, the magnitude of the number of time slices to be allocated in the number-based priority processing, the length of time slices to be allocated in the time-based priority processing, or the like.

For example, the time resource management unit 105 changes the insufficiency determination threshold value and acquires the degree of insufficiency of the time resource according to the change in the insufficiency determination threshold value. Then, the job deployment determination unit 104 notifies the priority processing determination unit 107 of the information about the degree of insufficiency of the time resource corresponding to the insufficiency determination threshold value acquired from the time resource management unit 105. Then, the priority processing determination unit 107 changes the degree of priority processing of the job to be prioritized according to the information about the degree of insufficiency of the time resource corresponding to the notified insufficiency determination threshold value.

The request transmission unit 106 receives an input of information about the input job and information about the calculation node 2 to be deployed from the job deployment determination unit 104. Furthermore, in a case where the time resource is insufficient, the request transmission unit 106 receives an input of a schedule of priority processing from the priority processing determination unit 107.

Then, in a case where the time resource is not insufficient, the request transmission unit 106 transmits a request for switching to the input job to a scheduler agent 20 of the designated calculation node 2. In addition, when the time resource is insufficient, the request transmission unit 106 transmits a request for a schedule of priority processing together with a request for switching to an input job to the scheduler agent 20 of the designated calculation node 2.

Here, in a case where the target job is an On-Demand job, there is no request for a schedule of priority processing, and the designated calculation node 2 is executing a Weak Batch job, the On-Demand job and the Weak Batch job are alternately executed in the same time slice. Execution of the On-Demand job and the Weak Batch job by the calculation node 2 in this case corresponds to an example of “first execution”. That is, in a case where the time resources are not tight, it can be said that the job deployment determination unit 104 allocates an equal time to the first job and the second job and causes the predetermined calculation node 2 to make the first execution. More specifically, it can be said that the job deployment determination unit 104 alternately allocates the time slice of a predetermined time length to the first job and the second job according to a lapse of time and causes the predetermined calculation node 2 to make the first execution.

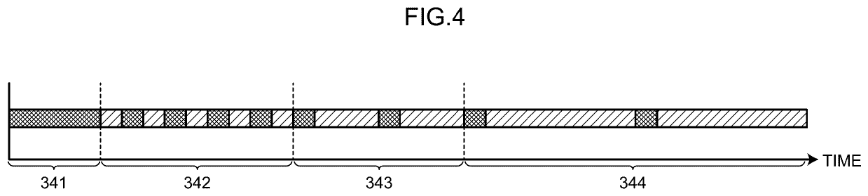

FIG. 4 is a diagram illustrating an example of job scheduling. In FIG. 4, a horizontal axis represents a lapse of time, and an execution state of a job in one calculation node 2 is illustrated. In FIG. 4, a gray filled region indicates that a Weak Batch job is executed, and a shaded region indicates that an On-Demand job is executed. Here, an overview of job scheduling by the management node 1 will be described with reference to FIG. 4.

In a case where the Weak Batch job and the On-Demand job are executed by node sharing, the management node 1 according to the present embodiment schedules each job as illustrated in FIG. 4, for example. When the Weak Batch job is input, the management node 1 executes the Weak Batch job in the section 341, and thereafter, when the On-Demand job is input, the management node 1 moves to execution of a job in node sharing.

While the time resource in the target calculation node 2 has a free space, the management node 1 fairly executes the Weak Batch job and the On-Demand job while causing the calculation node 2 to switch in round robin in the interval 342.

When the time resource is tight, the management node 1 determines that the time resource is insufficient, and preferentially executes the On-Demand job in the section 343. Thereafter, as illustrated in the section 344, the management node 1 can also execute the On-Demand job with a higher priority level than that of the section 343.

Here, since the time of execution of the actual job is not accurately known until the execution is completed, the management node 1 preferentially executes the On-Demand job to quickly eliminate the excessive reservation of the On-Demand job and free the time resource. As described above, by flexibly changing the priority according to the degree of tightness of the time resource, the management node 1 can make an early response instead of a sudden response after the time resource is insufficient.

Returning to FIG. 1, the description will be continued. Next, the calculation node 2 will be described. Each of the calculation nodes 2 includes the scheduler agent 20 and a job execution unit 21. The scheduler agent 20 includes a job management unit 201, a job switching unit 202, a time slice management unit 203, and a request reception unit 204.

The request reception unit 204 receives the request transmitted from the request transmission unit 106 of the management node 1 via the network. Then, the request reception unit 204 outputs the request to the time slice management unit 203.

In a case where the request does not include a request for a schedule of priority processing, the time slice management unit 203 outputs a job switching request to the job switching unit 202. However, in a case where the Weak Batch job and the On-Demand job are executed by node sharing, the time slice management unit 203 determines allocation of time slices so that the Weak Batch job and the On-Demand job are fairly executed while being switched in round robin. Then, a job switching request and information about the determined time slice are output to the job switching unit 202.

In a case where the request includes a request for a schedule of priority processing, the time slice management unit 203 determines when and how much the time slice is allocated to each job. Then, the time slice management unit 203 outputs the job switching request and information about the determined time slice to the job switching unit 202.

The job switching unit 202 receives an input of a job switching request from the time slice management unit 203. In addition, in a case where there is time slice information, the job switching unit 202 receives an input of the time slice information from the time slice management unit 203.

Then, the job switching unit 202 outputs a job switching instruction according to the request to the job management unit 201. Further, in a case where the information of the time slice is acquired, the job switching unit 202 counts the lapse of time using a timer included in the job switching unit, and in a case where the time of the time slice has elapsed, the job switching unit outputs a request for switching to the next job to the job management unit 201.

The job management unit 201 manages a job executed in the calculation node 2. The job management unit 201 receives a job switching instruction from the job switching unit 202. Then, when there is a job being executed by the job execution unit 21, the job management unit 201 causes the job execution unit 21 to switch the job to be executed from the job being executed to the designated job. In addition, when there is no job being executed, the job management unit 201 causes the job execution unit 21 to start execution of the designated job.

The job execution unit 21 executes a job deployed in the calculation node 2 in which the job execution unit operates. The job execution unit 21 switches a job to be executed in accordance with an instruction from the job management unit 201.

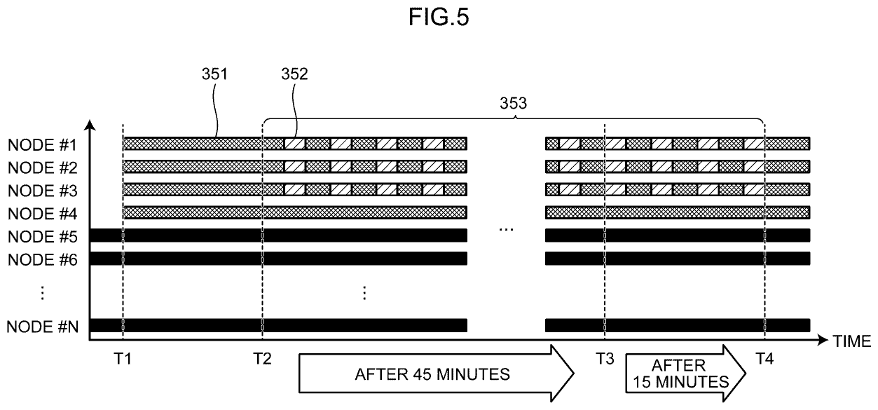

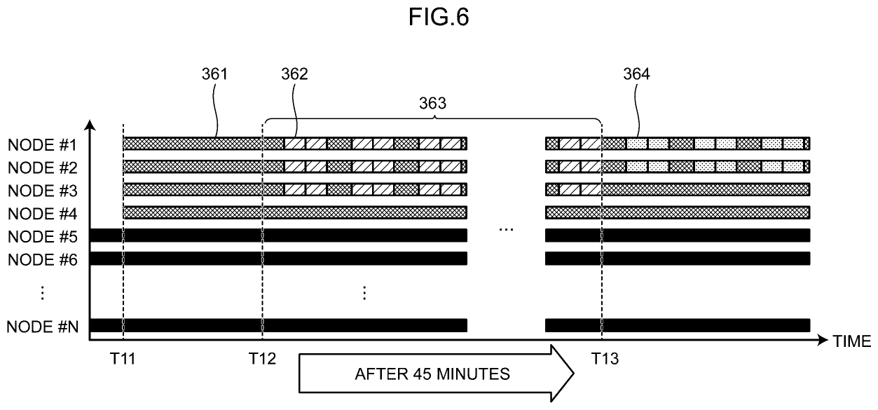

FIG. 5 is a diagram illustrating an example of an execution state of a job by gang scheduling. FIG. 6 is a diagram illustrating an example of an execution state of a job by the HPC system according to the embodiment. In FIGS. 5 and 6, the vertical axis represents each of the nodes #1 to #N, and the horizontal axis represents time. Next, with reference to FIGS. 5 and 6, a comparison between execution of a job by gang scheduling and execution of a job by the HPC system 100 according to the embodiment will be described.

Here, the following situation will be described as an example. The HPC system 100 is a cluster environment having nodes #1 through #N, which are N (N is a number greater than 4) calculation nodes 2. A Strict Batch job using N−4 calculation nodes 2 has already been executed. This Strict Batch job is a job that is executed for a long time, and does not end within the time described here. Next, a Weak Batch job that uses four calculation nodes 2 and has a maximum delay time designated as one hour is input to the HPC system 100. In this case, the management node 1 causes the four available calculation nodes 2 to execute the input Weak Batch job. As a result, there is no free calculation node 2. The input Weak Batch job is also a job that is executed for a long time, and does not end within the time described here. Next, a first On-Demand job that uses three calculation nodes 2 and has a maximum execution time designated as one hour is input to the HPC system 100. Since the maximum value delay time of the Weak Batch job whose execution is already started is one hour, the management node 1 causes the calculation node 2 to execute the Weak Batch job and the first On-Demand job in node sharing. Here, although the maximum execution time of the first On-Demand job is set to one hour, it is assumed that the first On-Demand job actually ends in 30 minutes. However, it is not clear to the management node 1 that the first On-Demand job actually ends in 30 minutes. Further, 45 minutes after the first On-Demand job is input, a second On-Demand job that uses two calculation nodes 2 and has a maximum execution time designated as 30 minutes is input to the HPC system 100.

When each job is executed by the gang scheduling under the above conditions, the execution state illustrated in FIG. 5 is obtained. In FIG. 5, the Strict Batch job is executed in the nodes #5 to #N. Then, at time T1, the Weak Batch job is input, and the nodes #1 to #4 execute the input Weak Batch job. Hatched regions 351 in the nodes #1 to #4 indicate that Weak Batch job is to be executed.

Next, the first On-Demand job is input at time T2. Due to the gang scheduling, the nodes #1 to #3 alternately execute the Weak Batch job and the first On-Demand job in the same time slice. The hatched regions 352 in the nodes #1 to #3 indicate that the first On-Demand job is executed. Here, the nodes #1 to #3 alternately execute the Weak Batch job and the first On-Demand job in the same time slice in the region 353, so that the first On-Demand job can be terminated 60 minutes after time T2. However, during the execution of the first On-Demand job, it is unknown when the execution of the first On-Demand job is completed.

Next, a second On-Demand job is input at time T3. At time T3, the resource for one hour from time T2 to time T4 during which the node can be shared in the Weak Batch job is reserved by allocation to the first On-Demand job, and there is no free node. Therefore, the second On-Demand job is not immediately executed. Therefore, execution of the second On-Demand job results in an error.

On the other hand, the HPC system 100 according to the present embodiment is in the execution state illustrated in FIG. 6. Also in FIG. 6, the Strict Batch job is executed in the nodes #5 to #N. Then, at time T11, the Weak Batch job is input, and the nodes #1 to #3 execute the input Weak Batch job. Regions 361 filled with gray in the nodes #1 to #3 indicate that Weak Batch jobs are to be executed.

Next, the first On-Demand job is input at time T12. The job deployment determination unit 104 of the management node 1 determines to cause the nodes #1 to #3 to execute the Weak Batch job and the first On-Demand job in node sharing. Since the WB job execution free resource until the end of the maximum execution time of the first On-Demand job is one hour and less than 10 hours, the time resource management unit 105 determines that the time resource is insufficient. Therefore, the priority processing determination unit 107 creates a schedule so that the priority of the first On-Demand job is increased and the time slice of the first On-Demand job is executed twice per time slice of the Weak Batch job. The hatched regions 362 in the nodes #1 to #3 indicate that the first On-Demand job is executed. As a result, the management node 1 causes the nodes #1 to #3 to repeat executing the Weak Batch job in one time slice and then executing the first On-Demand job in two time slices in the region 363. In this case, the first On-Demand job is completed 45 minutes after time T12, and 30 minutes after the excessively reserved time T13 are released.

Next, a second On-Demand job is input at time T13. At time T13, since there is a time resource of 30 minutes that can be used in node sharing, the second On-Demand job is immediately executed. In this case, notification of an error regarding execution of the second On-Demand job by the job deployment determination unit 104 is not made.

As described above, even in a case where the second On-Demand job is not executed and an error occurs in the gang scheduling, both the first On-Demand job and the second On-Demand job can be executed by using the HPC system 100 according to the embodiment.

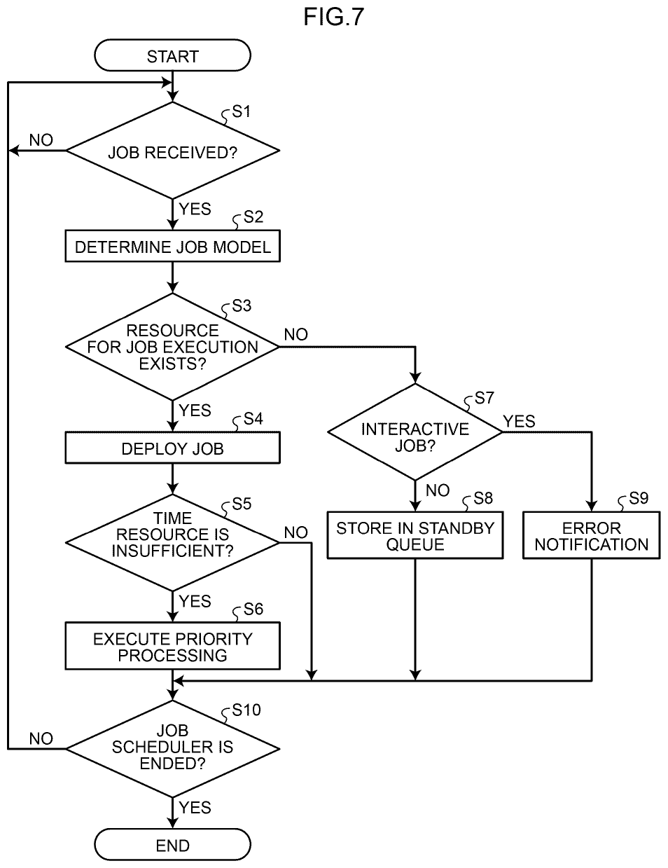

FIG. 7 is a flowchart of the job scheduling process by the job scheduler. Next, a flow of a job scheduling process by a job scheduler 10 will be described with reference to FIG. 7.

The job reception unit 101 receives the input job (step S1). Hereinafter, the input job is referred to as a “target job”.

The job model determination unit 102 acquires the target job from the job reception unit 101, and determines whether the job model of the target job is a Strict Batch job, a Weak Batch job, an On-Demand job, or a Spot job (step S2). The job information management unit 103 stores information about a target job, job input time, and information about a job model.

The job deployment determination unit 104 determines, for the target job, whether a resource for job execution exists based on the job model (step S3).

When a resource for job execution exists (step S3: yes), the job deployment determination unit 104 deploys the job to the calculation node 2 that can be used (step S4).

Next, the time resource management unit 105 determines whether the time resource is insufficient (step S5). In a case where the time resource is not insufficient (No in step S5), the scheduling process of the job proceeds to step S10.

On the other hand, when the time resource is insufficient (step S5: Yes), the priority processing determination unit 107 determines a job to be prioritized, and creates a schedule of priority processing by prioritizing the execution of the determined prioritized job (step S6). Then, the job scheduling process proceeds to step S10.

On the other hand, when there is no resource for job execution (step S3: No), the job deployment determination unit 104 determines whether the target job is an interactive job (step S7).

When the target job is not an interactive job (step S7: No), the job deployment determination unit 104 stores the target job in the standby queue (step S8). Then, the job scheduling process proceeds to step S10.

On the other hand, when the target job is an interactive job (step S7: yes), the job deployment determination unit 104 makes an error notification (step S9). Then, the job scheduling process proceeds to step S10.

Thereafter, in a case where the time resource is not insufficient, the request transmission unit 106 transmits a request for switching to the target job to the scheduler agent 20 of the calculation node 2 to which the job is deployed by the job deployment determination unit 104. In addition, in a case where the time resource is insufficient, the request transmission unit 106 transmits a request for switching to the target job and a request for a schedule of priority processing to the scheduler agent 20 of the calculation node 2 to which the job deployed by the job deployment determination unit 104. Thereafter, the request transmission unit 106 determines whether to terminate a job scheduler 10 (step S10). For example, the request transmission unit 106 can determine whether to terminate the job scheduler 10 according to whether to receive an input of an operation stop instruction from an administrator using an input device (not illustrated) has been received. When it is determined that the job scheduler 10 is not to be terminated (step S10: No), the job scheduling process returns to step S1. On the other hand, when it is determined that the job scheduler 10 is to be ended (step S10: yes), the job scheduler 10 stops the operation. Here, the request transmission unit 106 determines whether to end the job scheduler 10, but another function of the management node 1 may perform the determination.

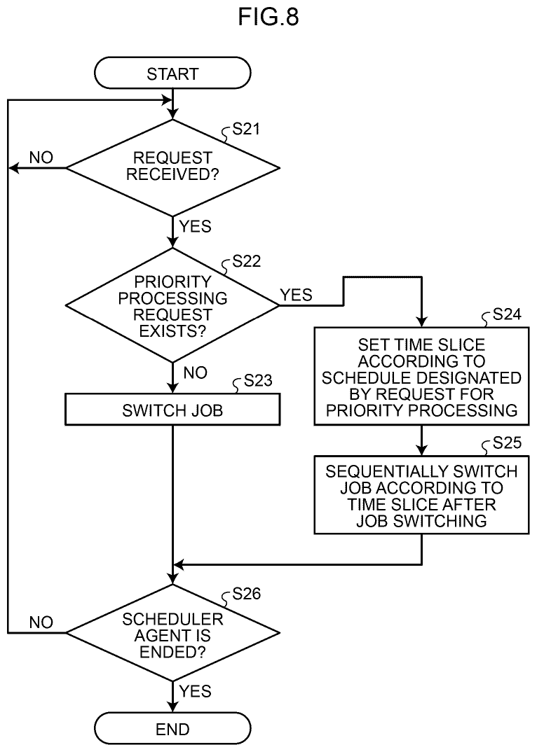

FIG. 8 is a flowchart of a job management process by the scheduler agent. Next, a flow of the job management process by the scheduler agent 20 will be described with reference to FIG. 8.

The request reception unit 204 receives the request transmitted from the request transmission unit 106 of the job scheduler 10 (step S21).

Next, the time slice management unit 203 determines whether a request for priority processing exists in the request received by the request reception unit 204 (step S22).

When there is no request for priority processing (step S22: No), the job switching unit 202 notifies the job management unit 201 of job switching. Upon receiving the notification of switching, the job management unit 201 switches the job to be executed by the job execution unit 21 to the target job designated in the request (step S23). At this time, in the case of execution of a job by node sharing, the job management unit 201 is instructed to alternately switch the job being executed and the target job for each time slice. Then, the job management process proceeds to step S26.

On the other hand, in a case where there is a request for priority processing (step S22: Yes), the time slice management unit 203 sets the time slice according to the schedule designated by the request for priority processing (step S24).

The job switching unit 202 instructs the job management unit 201 to switch between the running job and the target job according to the time slice set by the time slice management unit 203. In response to the instruction from the job switching unit 202, the job management unit 201 switch between the job being executed and the target job in accordance with the time slice to cause the job execution unit 21 to execute the job (step S25). Then, the job management process proceeds to step S26.

Thereafter, the job management unit 201 determines whether to end the scheduler agent 20 (step S26). For example, the job management unit 201 can determine whether to end the scheduler agent 20 according to whether to receive an input of an operation stop instruction from an administrator using an input device (not illustrated) has been received. When it is determined that the scheduler agent 20 is not to be terminated (step S26: No), the job management process returns to step S21. On the other hand, when it is determined that the scheduler agent 20 is to be ended (step S26: yes), the scheduler agent 20 stops the operation. Here, the job management unit 201 determines whether to end the job scheduler 10, but another function of the calculation node 2 may perform the determination.

As described above, the management node of the HPC system according to the present embodiment determines tightness of time resources when executing a Weak Batch job and an On-Demand job by time division using node sharing. Then, when the time resources are not tight, the management node causes the calculation node to alternately execute the Weak Batch job and the On-Demand job in the same time slice. On the other hand, when the time resource is tight, the management node increases the priority of the On-Demand job, allocates the time resource, causes the calculation node to execute the On-Demand job, and ends the On-Demand job early to make a margin in the time resource.

As a result, it is possible to advance the release of the overreserved resource, reduce the case where the resource is insufficient when the interactive job is input, and increase the possibility that the input interactive job can be immediately executed. In realization of interactivity, a probability that an input job is immediately executed is an important index, and user experience can be improved by improving the probability. Therefore, it is possible to improve processing performance while improving convenience.

### Hardware Configuration

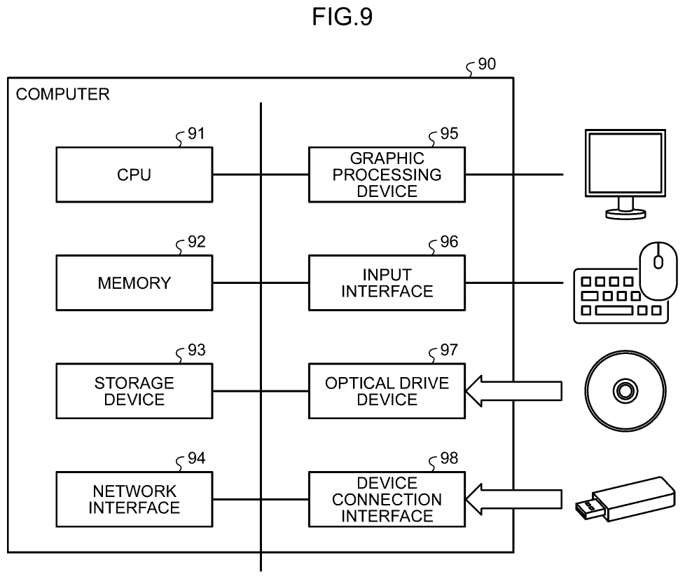

FIG. 9 is a hardware configuration diagram of a computer. Next, an example of a hardware configuration of a computer 90 for realizing the management node 1 and the calculation node 2 will be described with reference to FIG. 9.

The computer 90 includes, for example, a central processing unit (CPU) 91, a memory 92, a storage device 93, a network interface 94, a graphic processing device 95, an input interface 96, an optical drive device 97, and a device connection interface 98. The CPU 91, the memory 92, the storage device 93, the network interface 94, the graphic processing device 95, the input interface 96, the optical drive device 97, and the device connection interface 98 are communicably connected to each other via a bus.

The CPU 91 controls the entire computer 90. By executing the program, the CPU 91 implements the functions of the job scheduler 10 illustrated in FIG. 1 in the case of the management node 1, and implements the functions of the scheduler agent 20 and the job execution unit 21 in the case of the calculation node 2.

Note that the computer 90 may implement the functions of the job scheduler 10, the scheduler agent 20, and the job execution unit 21, for example, by executing a program recorded in a readable non-transitory recording medium.

A program describing processing content to be executed by the CPU 91 can be recorded in various recording media. For example, a program to be executed by the CPU 91 can be stored in the storage device 93. The CPU 91 loads at least part of the program in the storage device 93 into the memory 92 and executes the loaded program.

In addition, the program to be executed by the CPU 91 can be recorded in a non-transitory portable recording medium such as an optical disk, a memory device, or a memory card. The program stored in the portable recording medium can be executed after being installed in the storage device 93, for example, under the control of the CPU 91. The CPU 91 can also directly read and execute the program from the portable recording medium.

The memory 92 is a storage memory including a read only memory (ROM) and a random access memory (RAM). The RAM of the memory 92 is used as a main storage device of the computer 90. At least part of the program to be executed by the CPU 91 is temporarily stored in the RAM. The memory 92 also stores various pieces of data for processing by the CPU 91.

The storage device 93 is a storage device such as a hard disk drive (HDD), a solid state drive (SSD), or a storage class memory (SCM) to store various pieces of data. The storage device 93 is used as an auxiliary storage device of the computer 90.

The network interface 94 is connected to a network. The network interface 94 transmits and receives data via a network. Another information processing apparatus, communication equipment, or the like may be connected to the network.

A monitor is connected to the graphic processing device 95. The graphic processing device 95 displays an image on a screen of a monitor in accordance with a command from the CPU 91. For example, a keyboard and a mouse are connected to the input interface 96. The input interface 96 transmits a signal transmitted from a keyboard or a mouse to the CPU 91.

An optical drive device 97 reads data recorded on the optical disk using laser light or the like. The optical disk is a portable non-transitory recording medium on which data is recorded in a readable manner by reflection of light. Examples of the optical disk include a digital versatile disc (DVD), a DVD-RAM, a compact disc read only memory (CD-ROM), and a CD-recordable (R)/rewritable (RW).

The device connection interface 98 is a communication interface that connects a peripheral device to the computer 90. For example, a memory device or a memory reader/writer can be connected to the device connection interface 98. The memory device is a non-transitory recording medium having a communication function with the device connection interface 98, for example, a Universal Serial Bus (USB) memory. The memory reader/writer writes data to a memory card which is a card-type non-transitory recording medium or reads data from the memory card.

In an aspect, the present invention can improve processing performance while improving convenience.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a job execution control program that causes a computer to execute a process comprising:
receiving a first job for performing batch processing and a second job for performing interactive processing with a user;
determining tightness of a time resource used to cause a predetermined calculation node to alternately execute the first job and the second job according to a lapse of time;
in a case where the time resource is not tight, allocating an equal time to the first job and the second job and first causing the predetermined calculation node to make first execution; and
in a case where the time resource is tight, increasing priority of execution of the second job, allocating a time to the first job and the second job, and second causing the predetermined calculation node to make second execution.

2. The non-transitory computer-readable recording medium according to claim 1, wherein
the process further includes acquiring a maximum delay time that is an upper limit value of a delay of completion of execution of the first job and a maximum execution time that is an upper limit value of a time of execution of the second job, wherein
the determining includes determining tightness of the time resource based on the maximum delay time and the maximum execution time.

3. The non-transitory computer-readable recording medium according to claim 1, wherein
the first causing includes alternately allocating a time slice of a predetermined time length to the first job and the second job according to a lapse of time and causing the predetermined calculation node to make the first execution, and
the second causing includes increasing priority of execution of the second job, allocating the time slice, and causing the predetermined calculation node to make the second execution of the first job and the second job.

4. The non-transitory computer-readable recording medium according to claim 3, wherein the second causing includes increasing a number of time slices allocated to the second job, as compared with the number of time slices allocated to the first job.

5. The non-transitory computer-readable recording medium according to claim 3, wherein the second causing includes making a length of the time slice allocated to the second job longer than a length of the time slice allocated to the first job.

6. The non-transitory computer-readable recording medium having stored according to claim 1, wherein the second causing includes changing the priority according to a tight state of the time resource.

7. The non-transitory computer-readable recording medium according to claim 1, wherein
the receiving includes receiving the second job after receiving the first job and causing the predetermined calculation node to execute the first job, and
the determining includes determining tightness of the time resource when the predetermined calculation node is changed from a state of executing the first job to a state of alternately executing the first job and the second job.

8. The non-transitory computer-readable recording medium according to claim 1, wherein the process further includes:
determining whether the predetermined calculation node is capable of executing the second job;
in a case where the predetermined calculation node is capable of executing the second job, executing the determining; and
in a case where the predetermined calculation node is not capable of executing the second job, making a notification of an error.

9. A job execution control method comprising:
receiving a first job for performing batch processing and a second job for performing interactive processing with a user;
determining tightness of a time resource used to cause a predetermined calculation node to alternately execute the first job and the second job according to a lapse of time;
in a case where the time resource is not tight, allocating an equal time to the first job and the second job and first causing the predetermined calculation node to make first execution; and
in a case where the time resource is tight, increasing priority of execution of the second job, allocating a time to the first job and the second job, and second causing the predetermined calculation node to make second execution, using a processor.

10. A job execution control device comprising:
a processor configured to:
receive a first job for performing batch processing and a second job for performing interactive processing with a user;
determine tightness of a time resource used to cause a predetermined calculation node to alternately execute the first job and the second job according to a lapse of time;
in a case where the time resource is not tight, allocate an equal time to the first job and the second job and first cause the predetermined calculation node to make first execution; and
in a case where the time resource is tight, increasing priority of execution of the second job, allocate a time to the first job and the second job, and second cause the predetermined calculation node to make second execution.
